(19) United States
(12) Patent Application Publication
(10) Pub. No.: US 2023/0095652 A1
(43) Pub. Date: Mar. 30, 2023

(54) INFORMATION PROCESSING DEVICE, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Shinya NAKAMURA, Kanagawa (JP); Shintaro ADACHI, Kanagawa (JP); Akinobu YAMAGUCHI, Kanagawa (JP); Masanori YOSHIZUKA, Kanagawa (JP); Junichi SHIMIZU, Kanagawa (JP); Naomi TAKAHASHI, Kanagawa (JP); Kunihiko KOBAYASHI, Kanagawa (JP); Akane ABE, Kanagawa (JP)

(73) Assignee: FUJIFILM Business Innovation Corp., Tokyo (JP)

(21) Appl. No.: 17/699,155

(22) Filed: Mar. 20, 2022

(30) Foreign Application Priority Data
Sep. 27, 2021 (JP) 2021-157291

(51) Int. Cl. G06F 16/22

(52) U.S. Cl. CPC G06F 16/2282

(57) ABSTRACT

An information processing device includes a processor configured to perform a character recognition process on a form image containing data in a table format, and thereby acquire character strings of item names expressing items of the data in a table format and character strings of attribute values for the items, and change, in a case where a correspondence relationship between the attribute values for multiple items is undetermined, the correspondence relationship between the attribute values for the multiple items by using a height in the form image of the character string of the attribute value for which the correspondence relationship with the attribute value of another item is undetermined.

### CROSS-REFERENCE TO RELATED APPLICATIONS

This application is based on and claims priority under 35 USC 119 from Japanese Patent Application No. 2021-157291 filed Sep. 27, 2021.

### BACKGROUND

### (i) Technical Field

The present disclosure relates to an information processing device, an information processing method, and a non-transitory computer readable medium.

### (ii) Related Art

Japanese Patent No. 4996940 discloses a form recognition device that detects a region containing character strings from a form image, detects the character strings inside the detected region, recognizes the characters in the detected character strings using a recognition dictionary, cross-references the character recognition results of the character strings with item name words in an item name word registration dictionary, determines that a successfully cross-referenced character string is an item name character string, determines that an unsuccessfully cross-referenced character string is a data character string, and determines an attribute of the data character string from the positional relationship between the item name character string and the data character string.

### SUMMARY

When a character recognition process is performed on a form image containing data in a table format to acquire character strings of item names expressing items of data in the table format and character strings of attribute values for the items, in some cases, the layout of the table lacks gridlines or is an irregular layout containing explanatory text within the table. In such cases, the correspondence relationship between the acquired attribute values with respect to items may not be a 1:1 relationship, and in some cases, it may be difficult to determine the correspondence relationship.

Aspects of non-limiting embodiments of the present disclosure relate to performing a character recognition process on a form image containing data in a table format, and thereby associate attribute values for multiple items with each other when acquiring character strings of item names expressing items of data and character strings of attribute values for the items in the table format, even if the table has an irregular layout.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to: perform a character recognition process on a form image containing data in a table format, and thereby acquire character strings of item names expressing items of the data in a table format and character strings of attribute values for the items; and change, in a case where a correspondence relationship between the attribute values for a plurality of items is undetermined, the correspondence relationship between the attribute values for the plurality of items by using a height in the form image of the character string of the attribute value for which the correspondence relationship with the attribute value of another item is undetermined.

### BRIEF DESCRIPTION OF THE DRAWINGS

An exemplary embodiment of the present disclosure will be described in detail based on the following figures, wherein:

FIG. 1 is a diagram illustrating a system configuration of an information processing system according to an exemplary embodiment of the present disclosure;

FIG. 2 is a diagram illustrating one example of a document image containing data in a table format;

FIG. 3 is a diagram illustrating an example of a result of performing KV extraction on the form image of an order form illustrated in FIG. 2;

FIG. 4 is a diagram illustrating one example of a form image for which it is difficult to associate attribute values with each other by simply performing KV extraction alone;

FIG. 5 is a diagram illustrating a situation in which ordinary KV extraction is performed on the table contained in the form image illustrated in FIG. 4;

FIG. 6 is a diagram for describing a case where three attribute values are extracted as the character string of a single attribute value in a concatenated state;

FIG. 7 is a diagram illustrating a hardware configuration of a terminal device 10 in the information processing system according to an exemplary embodiment of the present disclosure;

FIG. 8 is a block diagram illustrating a functional configuration of the terminal device 10 in the information processing system according to an exemplary embodiment of the present disclosure;

FIG. 9 is a flowchart illustrating overall operations by the terminal device 10 when performing KV extraction;

FIG. 10 is a flowchart for describing the details of a process of correcting the KV extraction result in step S104 illustrated in the flowchart of FIG. 9;

FIG. 11 is a diagram illustrating one example of a case of adding an empty character string described in step S207;

FIG. 12 is a diagram illustrating an example of a KV extraction result in the case of removing a character string for which corresponding character strings do not exist;

FIG. 13 is a diagram illustrating one example of a case of dividing character strings of attribute values described in step S206;

FIG. 14 is a diagram illustrating one example of expressing the position and size of item name character strings and attribute value character strings extracted by a table KV extraction unit 33;

FIG. 15 is a diagram for describing a situation of comparing the height of a character string for a “Product Name” item to the heights of character strings for “Quantity” and “Unit Price” items;

FIG. 16 is a diagram for describing a situation of dividing the character string for the “Product Name” item into three in the height direction and thereby obtaining three character strings having a height of 20 pixels each;

FIG. 17 is a diagram for describing a situation of dividing the character string for the “Product Name” item into two character strings by setting the division location ⅔ down from the top; and

FIG. 18 is a diagram for describing a situation of dividing the character string for the “Product Name” item into two character strings by setting the division location ⅓ down from the top.

### DETAILED DESCRIPTION

Next, an exemplary embodiment of the present disclosure will be described in detail and with reference to the drawings.

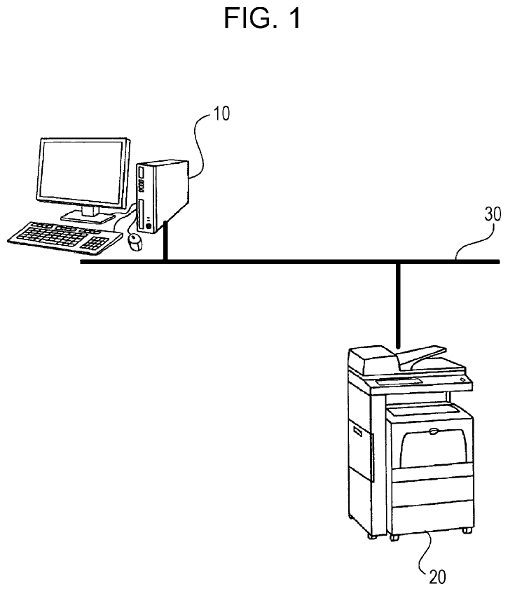

FIG. 1 is a diagram illustrating a system configuration of an information processing system according to an exemplary embodiment of the present disclosure.

As illustrated in FIG. 1, the information processing system according to an exemplary embodiment of the present disclosure includes an image forming device 20 and a terminal device 10 interconnected through a network 30. The image forming device 20 is a device referred to as a multi-function device, and includes multiple functions such as a print function, a scan function, a copy function, and a facsimile function.

The terminal device 10 is an information processing device provided with a function of receiving image data scanned in the image forming device 20 and executing an optical character recognition (OCR) process on the received image data to convert the image data to text data.

However, the image data to be subjected to the OCR process contains not only document image data of text only, but also data in a table format containing multiple rows and multiple columns in some cases.

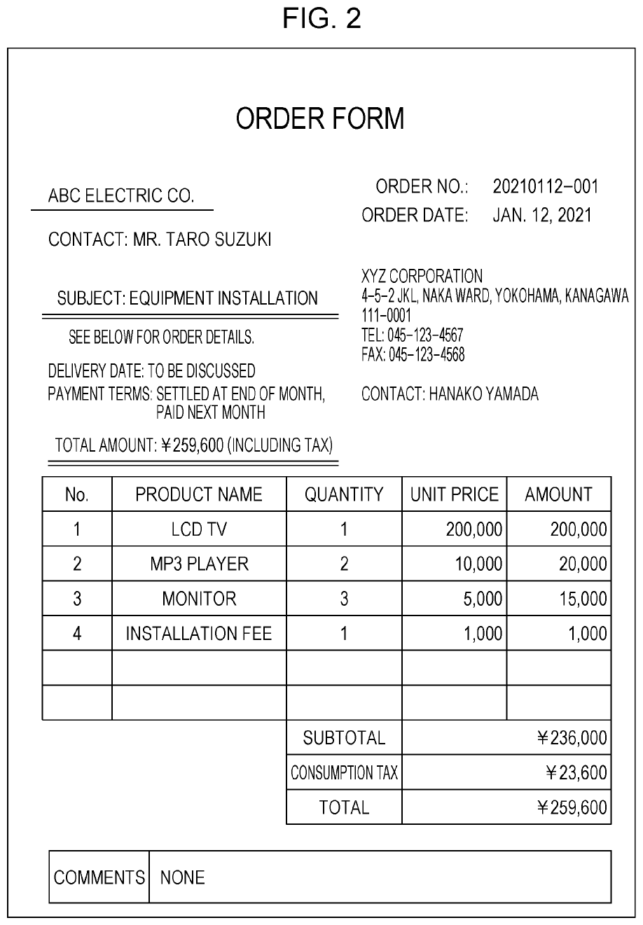

For instance, one example of a document image containing data in a table format in this way is illustrated in FIG. 2.

The document image example illustrated in FIG. 2 is an example of image data obtained by scanning an order form, and illustrates how the document image contains data in a table format including the product names, quantities, unit prices, and monetary amounts of ordered products.

In the case of a form like the above order form, generally, the uppermost row of the table includes the character strings of item names (keys) indicating the attributes of attribute values (values) included on the lower rows. Additionally, multiple attribute values are arranged below the item names. Furthermore, multiple attribute values exist with respect to a single item name in many cases.

For example, in the case of the table in the center of the order form image illustrated in FIG. 2, the four item names “Product Name”, “Quantity”, “Unit Price”, and “Amount” are listed in the uppermost row, and character strings are listed as attribute values below each of the item names.

For example, below the “Product Name” item name, the four character strings “LCD TV”, “MP3 Player”, “Monitor”, and “Installation Fee” are listed as attribute values.

As another example, below the “Quantity” item name, the four character strings “1”, “2”, “3”, and “1” are listed as attribute values.

Similarly, below the “Unit Price” item name, the four character strings “200,000”, “10,000”, “5,000”, and “1,000” are listed as attribute values, and below the “Amount” item name, the four character strings “200,000”, “20,000”, “15,000”, and “1,000” are listed as attribute values.

The process of performing a character recognition process on a form image containing data in a table format as above and acquiring character strings of item names (keys) expressing the items of the data in the table format and character strings of the attribute values (values) for the items is referred to as key-value (KV) extraction.

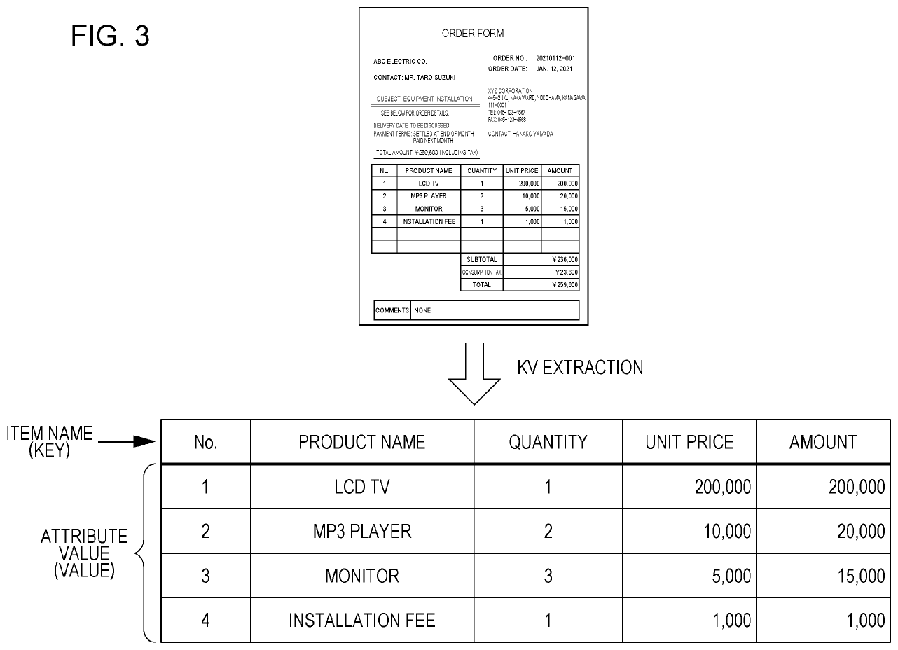

FIG. 3 illustrates an example of a result of performing KV extraction on the form image of an order form illustrated in FIG. 2. Referring to FIG. 3, four character strings are acquired as attribute values for each of the character strings of the item names “No.”, “Product Name”, “Quantity”, “Unit Price”, and “Amount”.

By performing KV extraction in this way, the character strings of the item names and attribute values are converted into text data by the character recognition process, and are thereafter usable as data.

Consequently, in the data obtained as a result of the KV extraction, it is desirable for the character strings of the respective attribute values on the same row to be associated with each other. For example, in the KV extraction result illustrated in FIG. 3, it is desirable for the attribute values “Monitor”, “3”, “5,000”, and “15,000” of the item names to be associated with each other as the attribute values on the third row.

However, depending on the layout of the table, the content listed in the table on the form image may have different numbers of character strings of the attribute values acquired with respect to each item name, and in some cases, it may be difficult to determine which attribute values should be associated with each other as attribute values belonging to the same row.

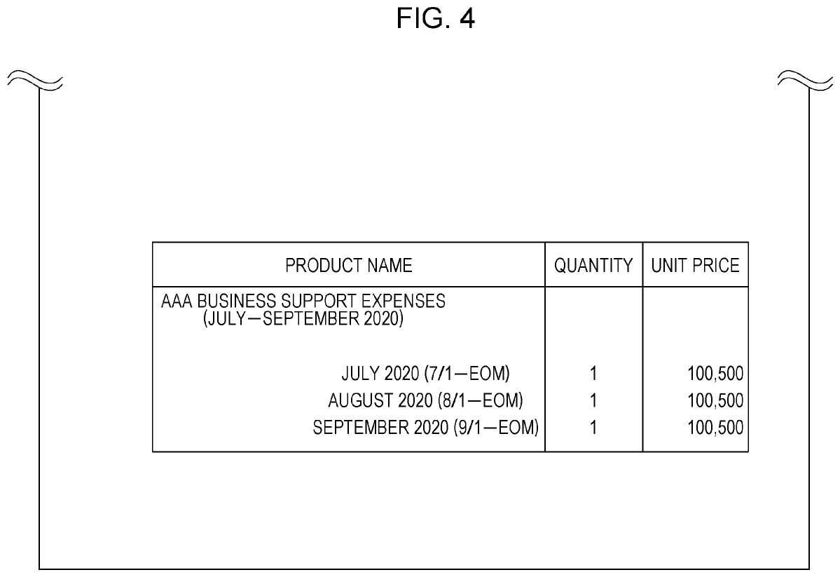

For instance, FIG. 4 illustrates one example of a form image for which it is difficult to associate attribute values with each other by simply performing KV extraction alone.

In the table included in the form image illustrated in FIG. 4, the character string “AAA Business Support Expenses (July-September 2020)” exists as explanatory content in the first row of the “Product Name” column, and consequently the number of attribute values differs between “Product Name” and the other item names “Quantity” and “Unit Price”. Note that such supplementary explanatory information is often listed in the column of an item name such as “Product Name”.

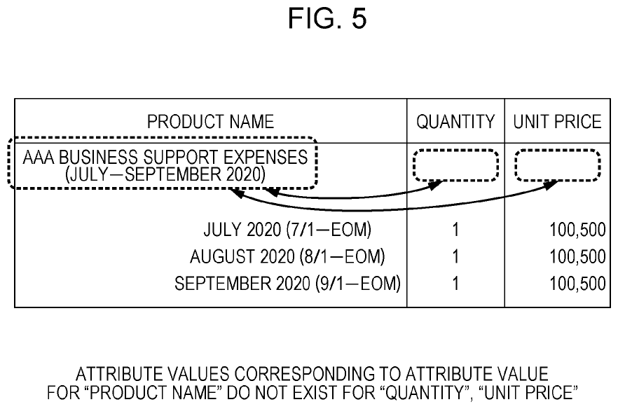

FIG. 5 illustrates a situation in which ordinary KV extraction is performed on a table in a format like the above.

As illustrated in FIG. 5, in the table included in the form image illustrated in FIG. 4, character strings corresponding to the character string of the attribute value “AAA Business Support Expenses (July-September 2020)” listed in the first row of the “Product Name” column do not exist as attribute values for “Quantity” and “Unit Price”.

For this reason, the number of attribute values differs among the item names, making it difficult to determine which attribute values should be extracted in association with each other as attribute values belonging to the same row, and there is a possibility that attribute values not originally associated with other may be extracted in association with each other.

Also, in the example of the table illustrated in FIG. 4, gridlines are not provided and there are narrow gaps between the rows of character strings, and consequently the “Product Name” character strings may be acquired as a single attribute value in a concatenated state in some cases.

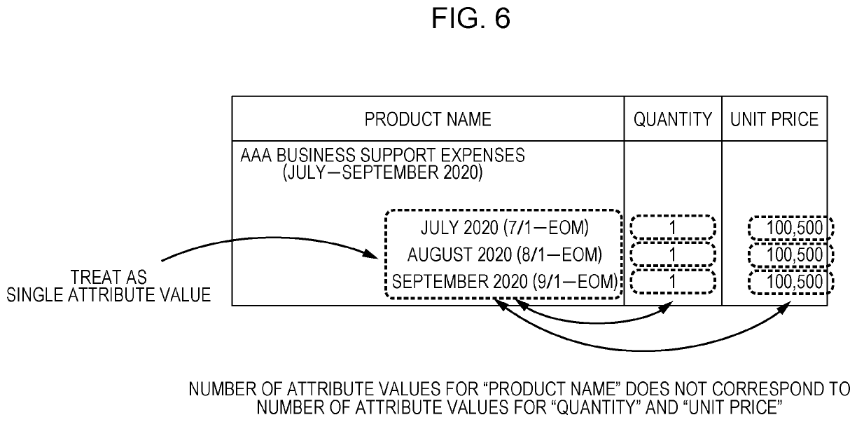

For example, as illustrated in FIG. 6, in some cases the three attribute values “July 2020 (7/1-EOM)”, “August 2020 (8/1-EOM)”, “September 2020 (9/1-EOM)” for the “Product Name” item name may be extracted in a concatenated state as the character string of a single attribute value. Additionally, if multiple character strings are extracted in a concatenated state as the character string of a single attribute value in this way, it may be difficult to determine the correspondence with attribute values for other item names. In cases like the one illustrated in FIG. 6, it may be difficult to determine how the character string of a single attribute value containing three attribute values in a concatenated state is associated with the three attribute values “1” and the three attribute values “100,500” for the “Quantity” and “Unit Price” item names.

Note that because attribute values for “Product Name” may be entered more freely compared to the attribute values for the items “Quantity” and “Unit Price”, there is a high probability that multiple character strings will be extracted in a concatenated state as a single character string.

Accordingly, by executing KV extraction as described hereinafter, the terminal device 10 according to the present exemplary embodiment is capable of associating attribute values for multiple items with each other, even if the table has an irregular layout.

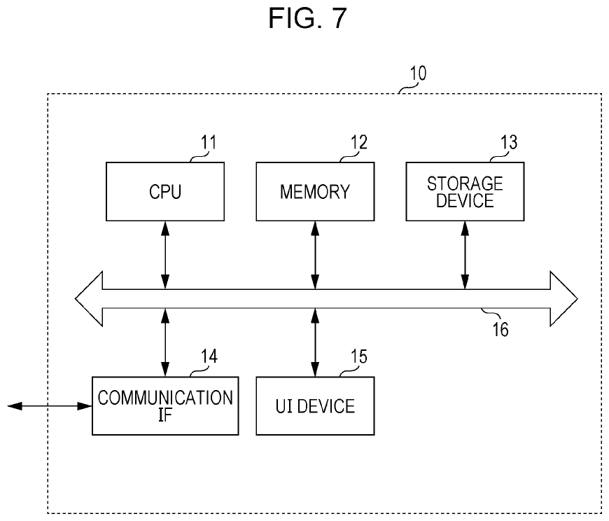

Next, a hardware configuration of the terminal device 10 in the information processing system according to the present exemplary embodiment is illustrated in FIG. 7.

As illustrated in FIG. 7, the terminal device 10 includes a CPU 11, a memory 12, a storage device 13 such as a hard disk drive, a communication interface (IF) 14 that transmits and receives data to and from external devices and the like over the network 30, and a user interface (UI) device 15 including a liquid crystal display and a keyboard. These components are interconnected through a control bus 16.

The CPU 11 is a processor that controls operations by the terminal device 10 by executing predetermined processes on the basis of a control program stored in the memory 12 or the storage device 13. Note that although the CPU 11 is described as reading out and executing a control program stored in the memory 12 or the storage device 13 in the present exemplary embodiment, the control program is not limited thereto. The control program may also be provided by being recorded onto a computer-readable recording medium. For example, the program may be provided by being recorded on an optical disc, such as a Compact Disc-Read-Only Memory (CD-ROM) or a Digital Versatile Disc-Read-Only Memory (DVD-ROM), or by being recorded on a semiconductor memory, such as Universal Serial Bus (USB) memory or a memory card. Additionally, the control program may also be acquired from an external device over a communication channel connected to the communication interface 14.

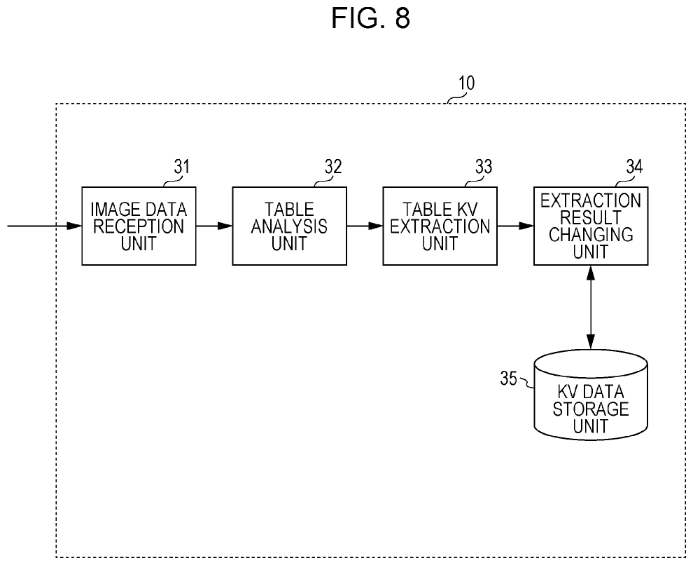

FIG. 8 is a block diagram illustrating a functional configuration of the terminal device 10 achieved by executing the above control program.

As illustrated in FIG. 8, the terminal device 10 according to the present exemplary embodiment is provided with an image data reception unit 31, a table analysis unit 32, a table KV extraction unit 33, an extraction result changing unit 34, and a KV data storage unit 35.

The image data reception unit 31 receives image data such as a form image over the network 30 from an external device such as the image forming device 20.

The table analysis unit 32 analyzes a table included in image data received by the image data reception unit 31, and acquires information about the table structure, such as the numbers of rows and columns, the position of the table in the image, and the like.

The table KV extraction unit 33 performs a character recognition process on the form image containing data in a table format on the basis of the result of the analysis of the table by the table analysis unit 32, and thereby performs KV extraction to acquire character strings of item names expressing items and character strings of attribute values for the items of the data in the table format.

In the case where the table KV extraction unit 33 is unable to determine the correspondence relationship between the attribute values for multiple items in the KV extraction, the extraction result changing unit 34 uses the height in the form image of the character strings of the attribute values for which the correspondence relationship with respect to the attribute values for other items has not been determined, and changes the correspondence relationship between the attribute values for multiple items. Here, the height in the form image is expressed as the length from the lower end to the upper end of a character when viewed from a direction such that the character is upright. Specifically, when a character string is upright, the height is expressed as the length occupied by the character string in the axis direction proceeding from the bottom edge to the top edge of a rectangular form image, for example. In the case where the form image is in a landscape orientation, the height in the form image is expressed as the length occupied by a character string in the axis direction proceeding from the right edge to the left edge, or from the left edge to the right edge, of a rectangular form image, for example.

Note that the extraction result changing unit 34 changes the correspondence relationship between the attribute values for multiple items by acquiring information about the coordinates, height, and width in the image of the character string of each attribute value extracted by the table KV extraction unit 33, and comparing properties such as the coordinates and the height between the attribute values for adjacent items. Here, the coordinates in the form image are expressed as positions in an X-axis direction and a Y-axis direction with respect to an origin set inside or outside the form image placed in the XY plane, for example.

For example, in the case where the height of the character string of an attribute value for a certain item is an integer multiple at least double the height of the attribute value for another item, the correspondence relationship between the attribute values for multiple items is changed by dividing the character string of the attribute value for the certain item in the height direction. Here, the integer multiple does not necessarily have to be a strict integer multiple, and may have an error range from 90% to 110% with respect to an integer multiple value.

Specifically, the extraction result changing unit 34 divides the character string of the attribute value for the certain item in the height direction such that the divided height of the character string of the attribute value for the certain item is substantially equal to the height of the character string of the attribute value for the other item. Here, substantially equal includes not only the case where the heights of the character strings are exactly equal, but also cases where the height of one character string is within a range from 90% to 110% with respect to the height of the other character string.

Note that in the case where a 1:1 relationship with the character string of the attribute value for the other item is not obtained even after dividing the character string of the attribute value for the certain item on the basis of the height of the character string of the attribute value for the other item, the extraction result changing unit 34 divides the character string of the attribute value for the certain item in the height direction to match the position, in the height direction, of the upper end of the character string of the attribute value for the other item.

This is because in the case where the numbers of attribute values for multiple items do not correspond in a 1:1 relationship, the character strings of the attribute values in the table are often arranged with top alignment.

Additionally, for an item not having an attribute value corresponding to the attribute value for the certain item, the extraction result changing unit 34 changes the correspondence relationship between the attribute values for multiple items by adding a character string indicating that a corresponding attribute value does not exist, such as an empty character string for example.

Furthermore, in the case where an attribute value corresponding to the attribute value for a certain item does not exist for any of the other items, the extraction result changing unit 34 may change the correspondence relationship between the attribute values for multiple items by removing the attribute value for the certain item.

Additionally, in the case of removing the attribute value for a certain item, the extraction result changing unit 34 may also notify the user of the removal of the attribute value.

Note that specific examples of when the extraction result changing unit 34 changes the correspondence relationship between the attribute values for multiple items will be described later.

The KV data storage unit 35 stores the KV extraction result that has been changed by the extraction result changing unit 34 as KV data.

Next, operations when performing KV extraction from inputted image data in the terminal device 10 according to the present exemplary embodiment will be described in detail with reference to the drawings.

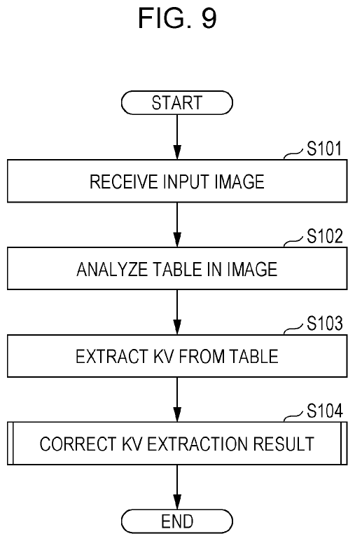

First, overall operations by the terminal device 10 when performing KV extraction are illustrated in the flowchart of FIG. 9.

First, when image data containing data in a table format is transmitted from an external device, in step S101, the image data reception unit 31 receives the transmitted image data.

Thereafter, in step S102, the table analysis unit 32 analyzes the table in the received image data. Next, in step S103, the table KV extraction unit 33 performs KV extraction to extract character strings of item names and character strings of attribute values for each item from the table in the image data.

Finally, in step S104, the extraction result changing unit 34 changes and corrects the correspondence relationship between the attribute values in the KV extraction result obtained by the table KV extraction unit 33 such that the attribute values for multiple items correspond in a 1:1 relationship.

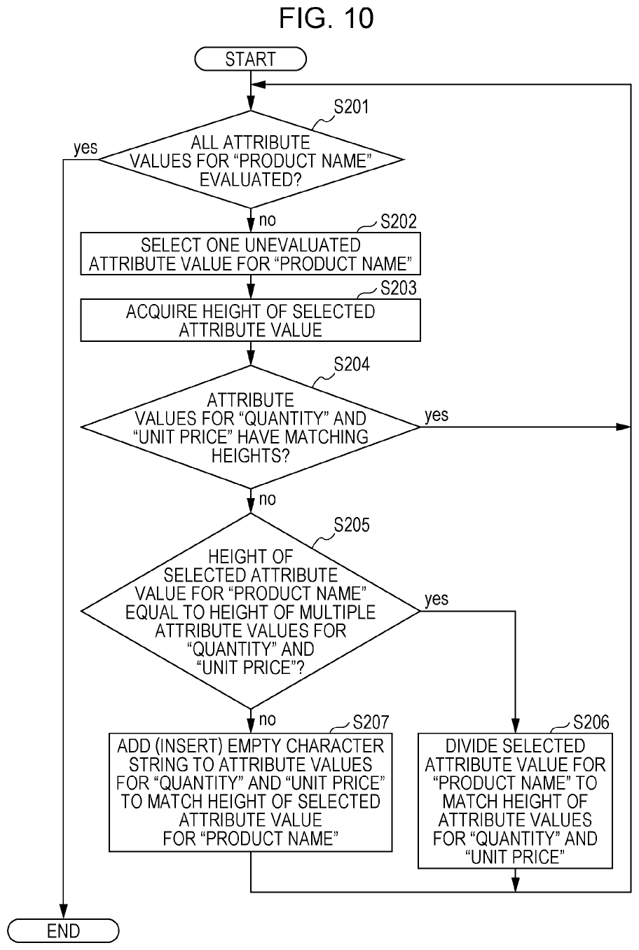

Next, details of the process of correcting the KV extraction result in step S104 illustrated in the flowchart of FIG. 9 will be described with reference to the flowchart of FIG. 10. Note that in the flowchart of FIG. 10, the case of a process performed on the document image illustrated in FIG. 4 is described specifically.

First, in step S201, the extraction result changing unit 34 determines whether or not the character strings of all attribute values for the “Product Name” item have been evaluated in the KV extraction result of the table format in the document image illustrated in FIG. 4. In the case where the character strings of all attribute values for the “Product Name” item have been evaluated, the extraction result changing unit 34 ends the process.

In the case where the character strings of all attribute values for the “Product Name” item have not been evaluated, in step S202, the extraction result changing unit 34 selects the character string of an unevaluated attribute value for “Product Name”.

In other words, the extraction result changing unit 34 evaluates the character strings of the attribute values for the “Product Name” item one at a time, and ends the process of correcting the KV extraction result after the character strings of all attribute values are evaluated.

Next, in step S203, the extraction result changing unit 34 acquires information about the height of the selected character string of the attribute value.

Additionally, in step S204, the extraction result changing unit 34 determines whether or not the height of the character string of the attribute value for the “Product Name” item matches the height of the character strings of the attribute values for the “Quantity” and “Unit Price” items.

In step S204, if the height of the character string of the attribute value for the “Product Name” item matches the height of the character strings of the attribute values for the “Quantity” and “Unit Price” items, the extraction result changing unit 34 determines that the correspondence relationship between the character string of the attribute value for the “Product Name” item and the character strings of the attribute values for the “Quantity” and “Unit Price” items is correct, and returns to the process in step S201.

On the other hand, in step S204, if the height of the character string of the attribute value for the “Product Name” item does not match the height of the character strings of the attribute values for the “Quantity” and “Unit Price” items, in step S205, the extraction result changing unit 34 determines whether or not the height of the selected character string of the attribute value for the “Product Name” item is equal to the height of multiple character strings of the attribute values for the “Quantity” and “Unit Price” items. In other words, the extraction result changing unit 34 determines whether or not the height of the character string of the attribute value for the “Product Name” item is an integer multiple at least double the height of the character strings of the attribute values for the “Quantity” and “Unit Price” items. As described above, the integer multiple at least double here is considered to be a value within an error tolerance range from 90% to 110% with respect to the value of a strict integer multiple.

In step S205, in the case of determining that the height of the selected character string of the attribute value for the “Product Name” item is equal to the height of multiple character strings of the attribute values for the “Quantity” and “Unit Price” items, in step S206, the extraction result changing unit 34 divides the selected character string of the attribute value for the “Product Name” item to match the height of the character strings of the attribute values for the “Quantity” and “Unit Price” items.

Also, in step S205, in the case of determining that the height of the selected character string of the attribute value for the “Product Name” item is not equal to the height of multiple character strings of the attribute values for the “Quantity” and “Unit Price” items, in step S207, the extraction result changing unit 34 adds or inserts empty character strings indicating that a corresponding character string does not exist as attribute values for the “Quantity” and “Unit Price” items to match the height of the selected character string of the attribute value for the “Product Name” item.

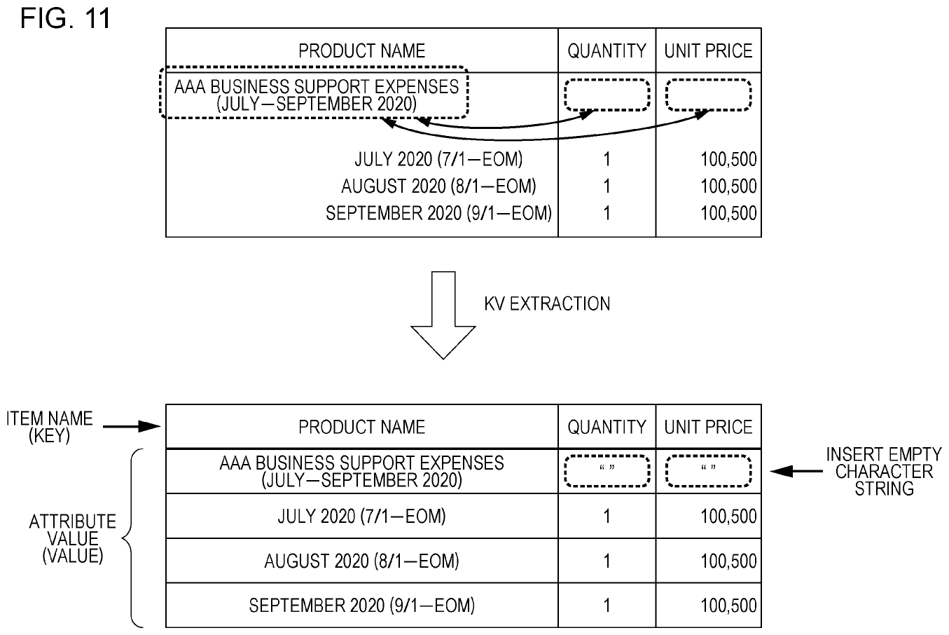

One example of the case of adding such empty character strings is illustrated in FIG. 11.

Referring to FIG. 11, the diagram illustrates how, in the data in a table format to be subjected to KV extraction, character strings corresponding to the character string “AAA Business Support Expenses (July-September 2020)” as an attribute value for “Product Name” do not exist as attribute values for the “Quantity” and “Unit Price” items.

For this reason, the extraction result changing unit 34 adds the character string “ ” as an empty character string indicating that a corresponding character string does not exist to the attribute values for the “Quantity” and “Unit Price” items in correspondence with the character string “AAA Business Support Expenses (July-September 2020)” for the “Product Name” item. Note that the empty character string is not limited to the character string “ ”, and a variety of character strings may also be used as the empty character string.

FIG. 11 illustrates a KV extraction result after adding the empty character string in this way, and illustrates how the character strings of all attribute values for the three items “Product Name”, “Quantity”, and “Unit Price” correspond in a 1:1 relationship.

Note that in step S207, in the case where character strings corresponding to the character string “AAA Business Support Expenses (July-September 2020)” as an attribute value for the “Product Name” item do not exist for the “Quantity” and “Unit Price” items, the extraction result changing unit 34 may also change the correspondence relationship between the attribute values for multiple items by removing the character string “AAA Business Support Expenses (July-September 2020)” for the “Product Name” item.

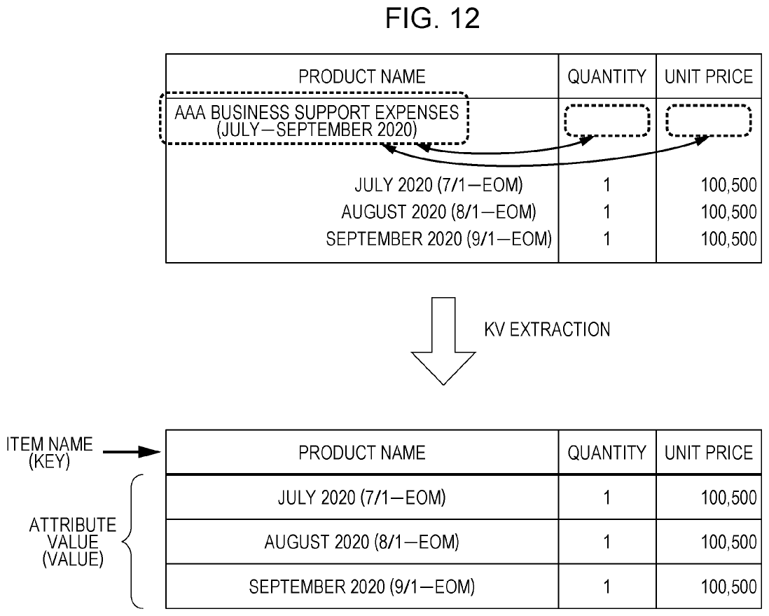

An example of a KV extraction result in the case of removing a character string for which corresponding character strings do not exist in this way is illustrated in FIG. 12. In FIG. 12, the character string “AAA Business Support Expenses (July-September 2020)” for which corresponding character strings do not exist in the “Quantity” and “Unit Price” items is removed. Consequently, the diagram illustrates how in the KV extraction result, the character strings of all attribute values for the three items “Product Name”, “Quantity”, and “Unit Price” correspond in a 1:1 relationship.

In the case of removing the attribute value for a certain item in this way, the extraction result changing unit 34 may also notify the user of the removal of the attribute value. For example, the extraction result changing unit 34 may include a comment indicating the removal of the attribute value in the KV extraction result stored in the KV data storage unit 35. Alternatively, when executing the KV extraction, the extraction result changing unit 34 may display a comment indicating the removal of the attribute value on a display device. For example, the extraction result changing unit 34 may cause a comment such as “The character string ‘AAA Business Support Expenses (July-September 2020)’ for ‘Product Name’ was removed because corresponding character strings do not exist in ‘Quantity’ and ‘Unit Price’.” to be displayed on a display device or included in the KV extraction result.

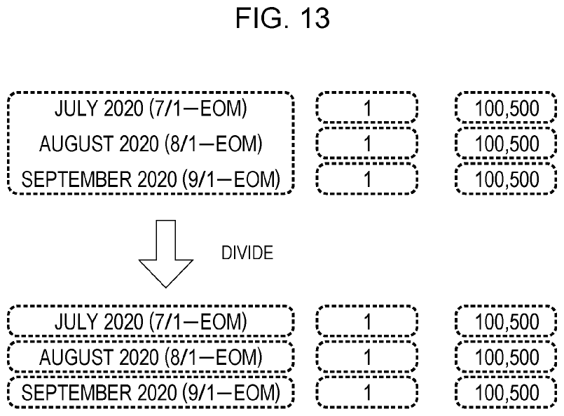

Next, FIG. 13 illustrates one example of a case of dividing the character strings of attribute values described in step S206 of the flowchart in FIG. 10.

Referring to FIG. 13, in the case where the three attribute values “July 2020 (7/1-EOM)”, “August 2020 (8/1-EOM)”, “September 2020 (9/1-EOM)” for the “Product Name” item name are extracted in a concatenated state as the character string of a single attribute value, the character strings are divided into three parts in the height direction to thereby obtain the three character strings “July 2020 (7/1-EOM)”, “August 2020 (8/1-EOM)”, “September 2020 (9/1-EOM)”.

In the case where multiple character strings are concatenated in the height direction to form a single character string in this way, dividing the character string in the height direction may improve the correspondence relationship between the character strings of all attribute values for multiple items.

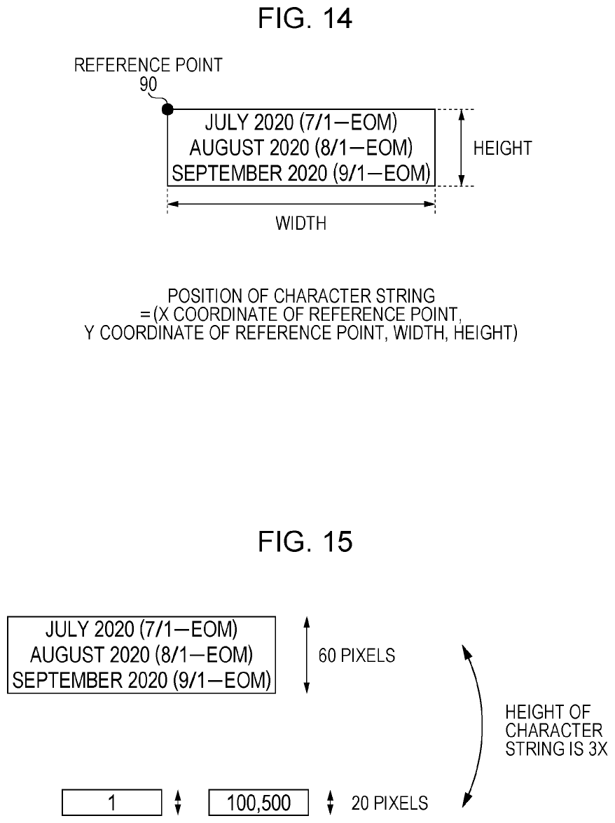

Next, FIGS. 14 to 16 will be referenced to describe specific processes when dividing a character string containing multiple character strings in a concatenated state.

The position and size of the character string of an item name or the character string of an attribute value extracted by the table KV extraction unit 33 is specified according to the method like the one illustrated in FIG. 14, for example. Specifically, the position and size of each character string in an image is understood from information indicating the X and Y coordinates in the image of a reference point 90 of the character string and the width and height of the character string.

For this reason, the extraction result changing unit 34 is capable of comparing the height of a character string for the “Product Name” item to the height of character strings for the “Quantity” and “Unit Price” items on the basis of the information indicating the height of each of the character strings, for example. Specifically, as illustrated in FIG. 15, in the case where the height of the character string for the “Product Name” item is 60 pixels and the height of the character strings for the “Quantity” and “Unit Price” items are 20 pixels, the extraction result changing unit 34 may determine that the height of the character string for the “Product Name” item is triple the height of the character strings for the “Quantity” and “Unit Price” items.

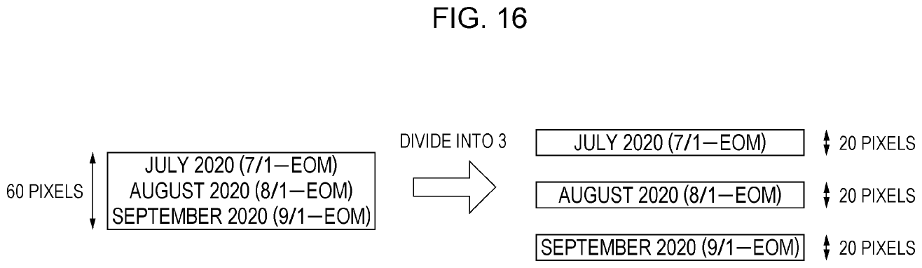

For this reason, as illustrated in FIG. 16, the extraction result changing unit 34 divides the character string for the “Product Name” item into three parts in the height direction, and thereby obtains three character strings each having a height of 20 pixels. As a result, the character strings of all attribute values for the three items “Product Name”, “Quantity”, and “Unit Price” correspond in a 1:1 relationship.

Note that in some cases, the correspondence relationship between the character strings of attribute values for multiple items may be so irregular that a 1:1 relationship is not achieved even after dividing the height of the character string for a certain item according to the height of the character string for another item.

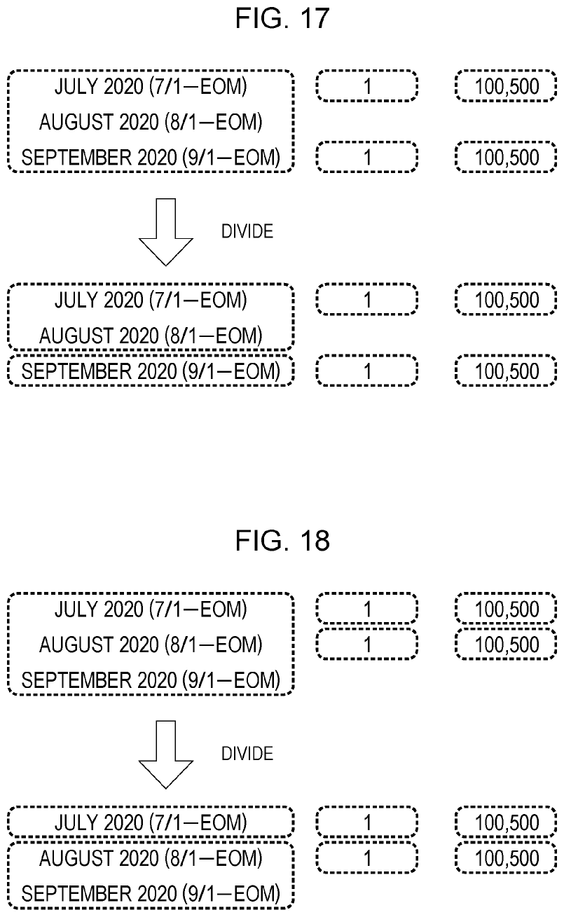

One example of such a case is illustrated in FIG. 17, in which even though the height of the character string for the “Product Name” item is triple the height of the character strings for the “Quantity” and “Unit Price” items, only two character strings exist as attribute values for each of the “Quantity” and “Unit Price” items. In such a case, even if the character string for the “Product Name” item is divided into three parts, a 1:1 relationship will not be achieved with the character strings for the “Quantity” and “Unit Price” items.

In such a case, as illustrated in FIG. 17, the extraction result changing unit 34 determines that the character strings of the attribute values for the “Quantity” and “Unit Price” items are top-aligned, divides the character string for the “Product Name” item into two character strings at a division location ⅔ down from the top, and respectively associates the two divided character strings with the character strings for the “Quantity” and “Unit Price” items.

Another example of the above case is illustrated in FIG. 18, in which even though the height of the character string for the “Product Name” item is triple the height of the character strings for the “Quantity” and “Unit Price” items, only two character strings exist as attribute values for each of the “Quantity” and “Unit Price” items. In the case illustrated in FIG. 18, the extraction result changing unit 34 likewise determines that the character strings of the attribute values for the “Quantity” and “Unit Price” items are top-aligned, divides the character string for the “Product Name” item into two character strings at a division location ⅓ down from the top, and respectively associates the two divided character strings with the character strings for the “Quantity” and “Unit Price” items.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Exemplary Modifications

The exemplary embodiment above is described using a case where KV extraction is executed in the terminal device 10 on image data scanned in the image forming device 20, but the present disclosure is not limited thereto and is also similarly applicable to cases where KV extraction is executed on a form image in any of various information processing devices.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
perform a character recognition process on a form image containing data in a table format, and thereby acquire character strings of item names expressing items of the data in a table format and character strings of attribute values for the items; and
change, in a case where a correspondence relationship between the attribute values for a plurality of items is undetermined, the correspondence relationship between the attribute values for the plurality of items by using a height in the form image of the character string of the attribute value for which the correspondence relationship with the attribute value of another item is undetermined.

2. The information processing device according to claim 1, wherein the processor is configured to change, in a case where the height of the character string of the attribute value for a certain item is an integer multiple at least double the height of the attribute value for another item, the correspondence relationship between the attribute values for the plurality of items by dividing the character string of the attribute value for the certain item in the height direction.

3. The information processing device according to claim 2, wherein the processor is configured to divide the character string of the attribute value for the certain item in the height direction such that the divided height of the character string of the attribute value for the certain item is substantially equal to the height of the character string of the attribute value for the other item.

4. The information processing device according to claim 2, wherein the processor is configured to divide, in a case where a 1:1 relationship with the character string of the attribute value for the other item is not obtained even after dividing the character string of the attribute value for the certain item on the basis of the height of the character string of the attribute value for the other item, the character string of the attribute value for the certain item in the height direction to match a position, in the height direction, of an upper end of the character string of the attribute value for the other item.

5. The information processing device according to claim 1, wherein the processor is configured to change, for an item not having an attribute value corresponding to the attribute value for the certain item, the correspondence relationship between the attribute values for the plurality of items by adding a character string indicating that a corresponding attribute value does not exist.

6. The information processing device according to claim 2, wherein the processor is configured to change, for an item not having an attribute value corresponding to the attribute value for the certain item, the correspondence relationship between the attribute values for the plurality of items by adding a character string indicating that a corresponding attribute value does not exist.

7. The information processing device according to claim 3, wherein the processor is configured to change, for an item not having an attribute value corresponding to the attribute value for the certain item, the correspondence relationship between the attribute values for the plurality of items by adding a character string indicating that a corresponding attribute value does not exist.

8. The information processing device according to claim 4, wherein the processor is configured to change, for an item not having an attribute value corresponding to the attribute value for the certain item, the correspondence relationship between the attribute values for the plurality of items by adding a character string indicating that a corresponding attribute value does not exist.

9. The information processing device according to claim 1, wherein the processor is configured to change, in a case where an attribute value corresponding to the attribute value for the certain item does not exist for any other item, the correspondence relationship between the attribute values for the plurality of items by removing the attribute value for the certain item.

10. The information processing device according to claim 2, wherein the processor is configured to change, in a case where an attribute value corresponding to the attribute value for the certain item does not exist for any other item, the correspondence relationship between the attribute values for the plurality of items by removing the attribute value for the certain item.

11. The information processing device according to claim 3, wherein the processor is configured to change, in a case where an attribute value corresponding to the attribute value for the certain item does not exist for any other item, the correspondence relationship between the attribute values for the plurality of items by removing the attribute value for the certain item.

12. The information processing device according to claim 4, wherein the processor is configured to change, in a case where an attribute value corresponding to the attribute value for the certain item does not exist for any other item, the correspondence relationship between the attribute values for the plurality of items by removing the attribute value for the certain item.

13. The information processing device according to claim 9, wherein the processor is configured to present a notification indicating the removal of the attribute value for the certain item.

14. The information processing device according to claim 10, wherein the processor is configured to present a notification indicating the removal of the attribute value for the certain item.

15. The information processing device according to claim 11, wherein the processor is configured to present a notification indicating the removal of the attribute value for the certain item.

16. The information processing device according to claim 12, wherein the processor is configured to present a notification indicating the removal of the attribute value for the certain item.

17. An information processing method comprising:
performing a character recognition process on a form image containing data in a table format, and thereby acquiring character strings of item names expressing items of the data in a table format and character strings of attribute values for the items; and
changing, in a case where a correspondence relationship between the attribute values for a plurality of items is undetermined, the correspondence relationship between the attribute values for the plurality of items by using a height in the form image of the character string of the attribute value for which the correspondence relationship with the attribute value of another item is undetermined.

18. A non-transitory computer readable medium storing a program causing a computer to execute a process comprising:
performing a character recognition process on a form image containing data in a table format, and thereby acquiring character strings of item names expressing items of the data in a table format and character strings of attribute values for the items; and
changing, in a case where a correspondence relationship between the attribute values for a plurality of items is undetermined, the correspondence relationship between the attribute values for the plurality of items by using a height in the form image of the character string of the attribute value for which the correspondence relationship with the attribute value of another item is undetermined.
